(19) United States
(12) Patent Application Publication
(10) Pub. No.: US 2012/0132040 A1
(43) Pub. Date: May 31, 2012

(54) PIVOTING-LEVER HAND TOOL WITH RESILIENT CLOSED-LOOP HANDLE

(76) Inventor: Jeffrey Mastroianni, Swansea, IL (US)

(21) Appl. No.: 13/307,100

(22) Filed: Nov. 30, 2011

Related U.S. Application Data
(60) Provisional application No. 61/417,920, filed on Nov. 30, 2010.

(51) Int. Cl. B25B 7/00; B25G 1/02

(52) U.S. Cl. 81/427

(57) ABSTRACT

A hand tool includes a rigid levers having a handle portions and jaw portions. The levers are pivotably interconnected to allow the jaws to move between an open position and a closed position. The hand tool further includes a resilient handle member having a first end and a second end opposite the first end. The first end of the resilient handle member is joined to the handle portion of the first lever, the second end of the resilient handle member is joined to the handle portion of the second lever. The resilient handle member extends in a substantially U-shaped configuration from the handle portions of the first and second levers. Pivoting of the first and second levers moving the jaws to the closed position causes temporary deformation of said handle member, and resiling of the handle member moves the jaws toward the open position.

### CROSS-REFERENCE TO RELATED APPLICATION

This application claims the benefit of priority under 35 U.S.C. 119(e) of U.S. Provisional Patent Application No. 61/417,920, filed Nov. 30, 2010, the entire disclosure of which is hereby incorporated herein by reference.

### FIELD OF THE INVENTION

The present invention relates generally to hand tools, and more particularly to a pivoting-lever hand tool, such as a pair of pliers for cutting wire, such as wire of a type often used to secure objects to consumer product packaging for toys and the like.

### BACKGROUND

Hand tools of various types, including wire-cutting pliers, are well-known in the art. However, the functional components of such hand tools/pliers are typically constructed entirely of rigid metal or other heavy materials. While such construction may make such tools suitable for certain industrial applications requiring extreme ruggedness, such weight is disadvantageous in light-duty applications, such as light-duty household use. Additionally, such tools may be difficult to operate by weaker or infirm persons that have relatively limited manual dexterity, particularly in operating the hand tool to pivot the tools jaws not only into a closed position, which requires relatively simple squeezing, but also to open the jaws, which requires move complex hand positions and increased dexterity relative to squeezing.

What is needed a hand-tool that addresses these needs, among others.

### SUMMARY

The present invention provides a hand tool. The hand tool includes a rigid first lever having a first handle portion and a first jaw portion and a rigid second lever having a second handle portion and a second jaw portion, said second lever being pivotably interconnected to said first levers to allow said first and second jaws to move between an open position and a closed position. The hand tool further includes a resilient handle member having a first end and a second end opposite the first end. The first end of the resilient handle member is joined to the handle portion of the first lever, the second end of the resilient handle member is joined to the handle portion of the second lever. The resilient handle member extends in a substantially U-shaped configuration from the handle portions of the first and second levers. Pivoting of the first and second levers moving the jaws to the closed position causes temporary deformation of said handle member. The resiling of the deformed handle member moves the jaws from the closed position toward the open position.

Optionally, the handle member is configured with a centrally-located living hinge and protruding shoulders to facilitate assembly of the handle member to the levers. Further, the handle member may include arcuate segments and/or operable living hinges adjacent the levers to promote localized flexing and deformation that facilitates resiling of the handle member and thus operation of the hand tool.

### BRIEF SUMMARY OF DRAWINGS

The present invention will now be described by way of example with reference to the following drawings in which:

FIG. 1 is a side view of a pivoting-lever hand tool with resilient closed-loop handle in accordance with an exemplary embodiment of the present invention;

FIG. 2A is a side view of a strap-like resilient handle member of the hand tool of FIG. 1;

FIG. 2B is a side view of the strap-like resilient handle member of FIG. 2A, showing the handle member bent into a substantially U-shaped configuration;

FIG. 3 is a perspective view of the pivoting-lever hand tool of FIG. 1, showing partial assembly of the handle member of FIG. 2B; and

FIG. 4 is a perspective view of the pivoting-lever hand tool of FIG. 1.

### DETAILED DESCRIPTION

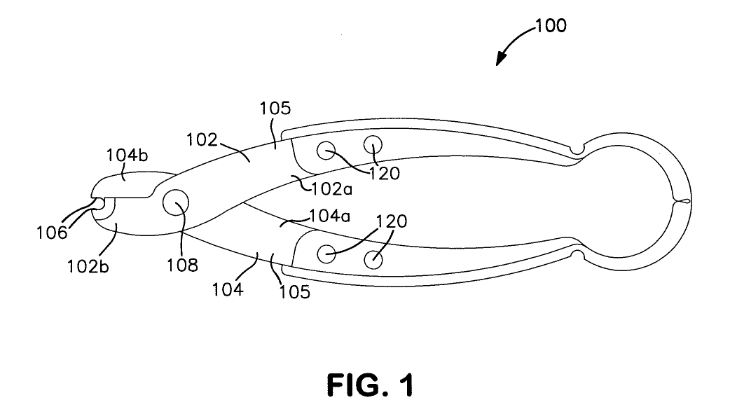

Referring now to FIGS. 1-4, an exemplary pivoting-lever hand tool is shown. The illustrated hand tool is exemplary of hand tools in accordance with the present invention in that it includes pivotable levers, and in that it further includes a resilient closed-loop handle member.

Referring now to FIGS. 1-4, the exemplary wire-cutting pivoting-lever hand tool is discussed in further detail. As shown in FIG. 1, the hand tool 100 includes rigid first and second levers 102, 104. Each lever 102, 104 includes a handle portion 102a, 104a and a jaw portion 102b, 104b. Both levers are rigid, in that they are constructed of a material, such as steel or another metal of a type typically used for pliers, scissors or other hand tools, that is sufficiently rigid to resist substantial deformation during manual use to cut wire. By way of example, suitable rigid levers may be formed by conventional stamping or forging operations.

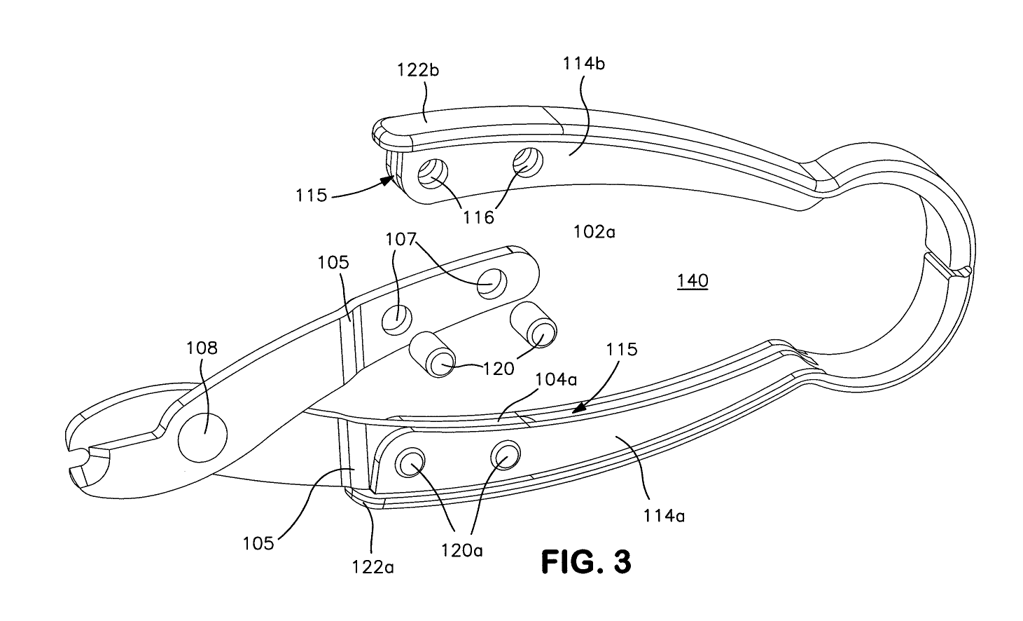

Each lever 102, 104, may be non-planar in that they may include an offset 105 such the jaw and handle portions of a single lever lie in separate planes. As a result of the offsets, the respective handle portions 102a, 102b of levers 102 and 104 are co-planar when assembled for pivoting, as best shown in FIGS. 1 and 3. The levers 102, 104 may be identical.

The illustrated hand tool is configured as a wire cutter, in that the pivotable levers include jaw portions configured for cutting wire, such as 14-gauge 110 VAC electrical wire, or wires of a type typically used in consumer product packaging, such as those commonly used to secure children's toys within cardboard or paperboard boxes. Accordingly, the first and second levers have cutting surfaces 106 configured to cooperate to shear wire placed therebetween. Further, the exemplary jaw portions have a rounded leading edge 113 (FIG. 1) to provide a “snubbed” nose intended to minimize injuries. However, it should be noted that the jaws are so configured in this exemplary tool for illustrative purposes only, and that any suitable configuration of levers and jaws may be employed consistent with the present invention.

The exemplary tool 100 further includes a rigid pivot pin 108, such as a rivet, pivotably interconnecting the first and second levers 102, 104. Such pivoting allows the jaws 102b, 104b, of the first and second levers 102, 104 to move between an open position (jaws separated) and a closed position (jaws closed/cutting surfaces mating).

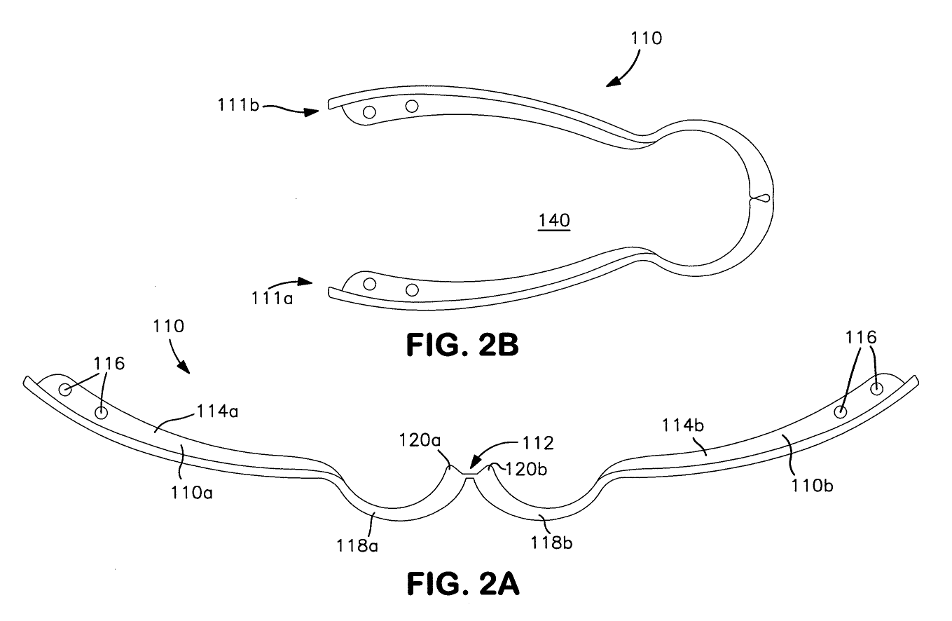

The tool 100 further includes a handle member 110. The handle member 110 is resilient, in that it is constructed of a flexible material that is readily deformable during manual operation of the tool, and that tends to resile in response to such deformation. Suitable resilient materials include various plastic and rubber materials. The handle member 110 is preferably formed as an elongated, continuous strap-like member, e.g. by injection molding of fluent plastic material, using a suitable mold. Preferably, the handle member 110 is formed such that one half 110a is a mirror-image of the other 110b, and that the two halves are separated by a centrally-located integral living hinge 112, as best shown in FIG. 2A.

Preferably, each half 110a, 110b of the handle member 110 is formed to include a central rib 114a, 114b having openings 116 for receiving a fastener for attaching the handle member to the levers 102, 104, as best shown in FIG. 2A. Each central rib defines a central slot 115 for receiving a respective one of the levers, as best shown in FIG. 3.

Further, each half 110a, 110b of the handle member 110 may include an arcuate segment 118a, 118b adjacent the centrally-located living hinge 112, and protruding shoulders 120a, 120b (as shown in FIG. 2A) positioned to impinge upon one another to facilitate resilient biasing of the handle member 110 when in its operable position (as shown in FIGS. 1 and 2B).

Each half 110a, 110b further includes a bearing surface 122a, 122b extending generally transversely to the central ribs 114a, 114b as best shown in FIGS. 2A and 3. The bearing surface 122a, 122b facilitates manual grasping of the tool 100 and provides a comfortable grip for squeezing the handle member and causing pivoting of the levers 102, 104.

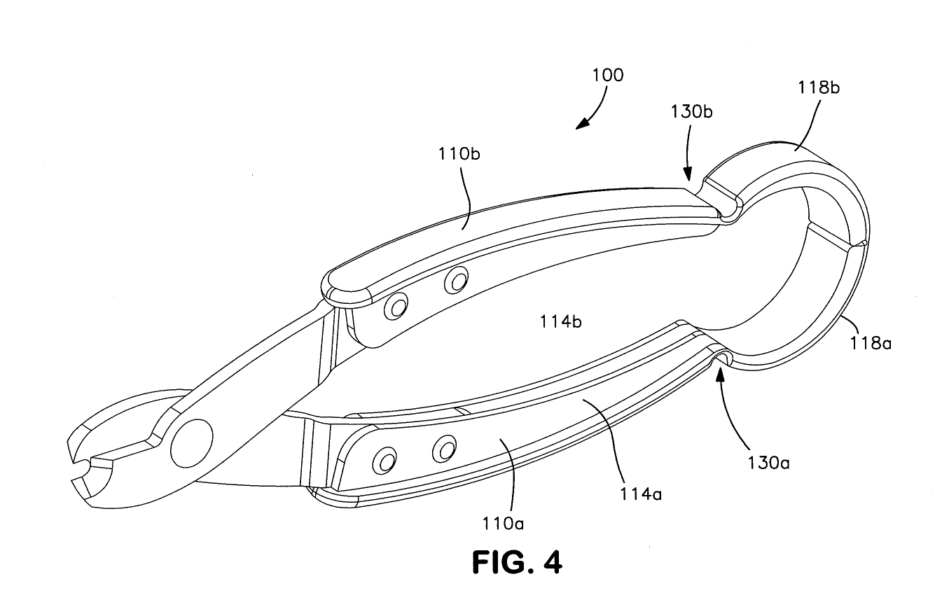

In a preferred embodiment, the handle member 110 further includes operable living hinges 130a, 130b, each of which is disposed between an arcuate portion 118a, 118b and a corresponding handle portion of a half 110a, 110b (or rib 114a, 114b). These operable living hinges 130a, 130b, may be provides as a region having a reduced cross-sectional area, as best shown in FIGS. 1 and 4. These living hinges 130a, 130b have greater flexibility relative to immediately adjacent portions of the handle member, thus promoting localized flexing at the living hinge under a load on the handle member.

Adjacent the operable living hinges 130a, 130b, the handle member 110 includes complementary stops 134a, 134b. These stops 134a, 134b are preferably mirror images of one another, as discussed above. The stops cooperate to impinge upon one another during operation of the tool to limit the extent of pivoting action of the levers 102, 104 at the closed position. By varying the configuration of these stops, the range of pivoting motion of the levers can be controlled. For example, increasing the height of the stops correspondingly decreases the range of pivoting motion of the levers.

To assemble the tool, the handle member 110 is bent from its initial elongated strap-like configuration to a substantially U-shaped configuration, as best shown in FIGS. 2B and 3. Such bending is facilitated by the centrally-located living hinge 112. This living hinge thus facilitates bending for assembly purposes but does not provide substantial flexing during use, but rather remains in tension as a result of the abutment of shoulders 120a, 120b, as best shown in FIGS. 1 and 4. Molding the handle member in an elongated configuration and subsequently bending the handle member for assembly simplifies the molding process and/or tooling, and also serves to preload the handle member with some resilient biasing as a result of the deformation. Further, this configuration causes the assembled tool to having a strap-like resilient handle member that extends away from the levers 102, 104 in a substantially U-shaped configuration, imparting a generally closed-looped configuration to the tool and handle, and leaving a region 140 between the levers/handle members unobstructed, with the connecting arcuate portions 118a, 118b positioned outside of the unobstructed region 140 between the handle portions 102a, 102b of the levers 102, 104. This unobstructed region 140 (FIGS. 2B, 3) can be used to provide clearance for the fingers during operation and/or carrying of the hand tool, and the overall closed-loop configuration allows the tool to be hung from its handle member 110 in inverted fashion on a peg, hook, etc.

The ends 111a, 111b (FIG. 2B) of the handle member 110 are joined to the handle portions 102a, 102b of the levers 102, 104. In this example, they are so joined by pins 120 press-fit or otherwise fastened through the openings 116 of the handle member 110, and through corresponding openings 107 of the handle portions of the levers, as best shown in FIGS. 1 and 3.

After assembly of the finished tool, as shown in FIG. 1, the tool is operable somewhat similarly to ordinary pliers. Generally, the tool 100 may be manually grasped by the handle member 110, and the bearing surfaces 122a, 122b may be manually squeezed together. Such squeezing causes pivoting of the first and second levers 102, 104 about the pivot pin 108, and thus causes moving of the jaws 102b, 104b toward a closed position (best shown in FIG. 1). As the jaws are moved toward the closed position, the cutting surfaces 106 will cut a wire positioned therebetween. Such squeezing causes temporary deformation of the handle member 110, particularly in the arcuate regions 118a, 118b, shoulders 120a, 120b and living hinge 112.

After completing a cutting operation, the user may relax his/her grip on the tool's handle member 110. In the event of reduced squeezing, the deformed resilient handle member 110 resiles and moves the jaws 102b, 104b from the closed position toward the open position, effectively resetting the tool for use.

While the present invention has been particularly shown and described with reference to the preferred mode as illustrated in the drawing, it will be understood by one skilled in the art that various changes in detail may be effected therein without departing from the spirit and scope of the invention as defined by the claims.

I claim:

1. A hand tool comprising:
a rigid first lever having a first handle portion and a first jaw portion;
a rigid second lever having a second handle portion and a second jaw portion, said second lever being pivotably interconnected to said first levers to allow said first and second jaws to move between an open position and a closed position; and
a resilient handle member having a first end and a second end opposite the first end, the first end of the resilient handle member being joined to the handle portion of the first lever, the second end of the resilient handle member being joined to the handle portion of the second lever, the resilient handle member extending in a substantially U-shaped configuration from the handle portions of the first and second levers.

2. The hand tool of claim 1, wherein each of the first and second levers is configured with an offset such that the jaw and handle portions of each lever lie in separate planes.

3. The hand tool of claim 2, wherein said first lever is identical to said second lever.

4. The hand tool of claim 1, wherein said resilient handle member is formed as a continuous strap-like member.

5. The hand tool of claim 1, wherein the handle member is formed to include two identical halves separated by a centrally-located integral living hinge.

6. The hand tool of claim 5, wherein each half comprises an arcuate segment adjacent the centrally-located living hinge, and a protruding shoulder, the protruding shoulders being positioned to impinge upon one another when the hand tool is in an operable position.

7. The hand tool of claim 5, wherein each half comprises a central rib defining a central slot for receiving a respective one of the levers.

8. The hand tool of claim 7, wherein each central rib and each lever comprises at least one opening for receiving a fastener for attaching the handle member to each lever.

9. The hand tool of claim 7, wherein each half comprises a bearing surface extending generally transversely to a respective central rib.

10. The hand tool of claim 5, where each half further comprises an operable living hinge.

11. The hand tool of claim 10, wherein each operable living hinge has a reduced cross-sectional area relative to a cross-sectional area of adjacent portions of the handle member.

12. The hand tool of claim 10, wherein each half comprises a stop, the stops being positioned to impinge upon one another when the jaws are in the closed position.

13. The hand tool of claim 1, wherein each jaw portion has a rounded leading edge.

14. A hand tool comprising:
rigid first lever and second levers, each having a handle portion and a jaw portion;
a pivot pin pivotably interconnecting said first and second levers to allow the jaws of said first and second levers to move between an open position and a closed position; and
a continuous, unitary resilient handle member having a first end and a second end opposite the first end, the first end of the resilient handle member being joined to the handle portion of the first lever, the second end of the resilient handle member being joined to the handle portion of the second lever, the resilient handle member extending in a substantially U-shaped configuration from the handle portions of the first and second levers;
whereby pivoting of said first and second levers moving said jaws to the closed position causes temporary deformation of said handle member; and
whereby resiling of said deformed handle member moves said jaws from the closed position toward the open position.

15. The hand tool of claim 14, wherein the handle member comprises a pair of bearing surfaces and is formed to include a centrally-located integral living hinge, the handle member further comprising a pair of arcuate segments, each of which is disposed between said centrally-located living hinge and a respective one of said bearing surfaces.

16. The hand tool of claim 15, further comprising an operable living hinge disposed between each one of said pair of arcuate segments and a respective one of said pair of bearing surfaces.

17. The hand tool of claim 16, wherein each one of said pair of bearing surfaces supports a central rib defining a central slot for receiving a respective one of said levers.

18. The hand tool of claim 17, wherein each central rib and each lever comprises at least one opening for receiving a fastener for attaching the handle member to each lever.

19. A hand tool comprising:
rigid first lever and second levers, each having a handle portion and a jaw portion;
a pivot pin pivotably interconnecting said first and second levers to allow the jaws of said first and second levers to move between an open position and a closed position; and
a continuous, unitary resilient handle member having a first end and a second end opposite the first end, the first end of the resilient handle member being joined to the handle portion of the first lever, the second end of the resilient handle member being joined to the handle portion of the second lever, the resilient handle member extending in a substantially U-shaped configuration from the handle portions of the first and second levers, the handle member further comprising:
a pair of stops, the stops being positioned to impinge upon one another when the jaws are in the closed position;
a pair of bearing surfaces;
a centrally-located integral living hinge;
a pair of protruding shoulders adjacent said centrally-located living hinge and abutting upon one another when the hand tool is in the open and closed positions;
a pair of arcuate segments, each of which is disposed between said centrally-located living hinge and a respective one of said bearing surfaces;
a pair of operable living hinges, each of which is disposed between each one of said pair of arcuate segments and a respective one of said pair of bearing surfaces; and
a central rib defining a central slot for receiving a respective one of said levers, each central rib being supported on a respective one of said pair of bearing surfaces, each central rib and each lever comprising at least one opening for receiving a fastener for attaching the handle member to each lever;
whereby pivoting of said first and second levers moving said jaws to the closed position causes temporary deformation of said operable living hinges and said pair of arcuate segments; and
whereby resiling of said deformed handle member moves said jaws from the closed position toward the open position.
